(19) United States
(12) Patent Application Publication
(10) Pub. No.: US 2006/0040693 A1
(43) Pub. Date: Feb. 23, 2006

(54) Apparatus and method for processing call in Push-To-Talk system

(76) Inventors: Seung-Il Yoon, Seongnam-si (KR); Dong-Keon Kong, Suwon-si (KR); Sung-Kwon Jo, Suwon-si (KR); Jae-Hyok Lee, Seoul (KR); In-Ky Cho, Hwaseong-si (KR); Ji-Won Lee, Seongnam-si (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 11/195,862

(22) Filed: Aug. 3, 2005

(30) Foreign Application Priority Data
Aug. 5, 2004 (KR) 2004-61843

(51) Int. Cl. H04Q 7/20

(52) U.S. Cl. 455/519; 455/456.1

(57) ABSTRACT

An apparatus and method for processing a call in a PTT system where, when an outgoing terminal transmits an invitation message for PTT service or for call setup to a predetermined incoming terminal in a dormant state, the outgoing terminal transmits the invitation message together with address information on the incoming terminal to enable a PTT server to detect the location of the incoming terminal before the invitation message is transmitted to the incoming terminal, thereby reducing the time taken to set up a PTT call.

### CROSS-REFERENCE TO RELATED APPLICATION

This application claims benefits under 35 U.S.C. §119 from a Korean Patent Application Serial No. 2004-0061843 filed in the Korean Intellectual Property Office on Aug. 5, 2004 the entire disclosure of which is hereby incorporated by reference.

### BACKGROUND OF THE INVENTION

1. Field of the Invention

The present invention relates to a call process in a Push-To-Talk (PTT) system. More particularly, the present invention relates to an apparatus and method for processing a call in a PTT system, for reducing a time taken to set up a call between an outgoing terminal and an incoming terminal, for a PTT service.

2. Description of the Related Art

Push-To-Talk (PTT) service is an instant messenger service which is a type of radio communication service. PTT service allows a service subscriber to push a button on a terminal to talk, thereby instantly communicating in a simple manner. Accordingly, the PTT service enables very quick communication compared to a standby time of a general mobile phone.

Further, the PTT service for a group of subscribers is performed in such a manner that when one subscriber pushes to talk, the other subscribers can all hear using their terminals. Accordingly, the PTT service is not limited to communication between only two terminals like a telephone. Here, the PTT service subscriber can designate a small or medium-sized group of subscribers as contacts, and can also perform one-to-one radio communication.

The PTT service is based on Session Initiation Protocol (SIP) which is a text-based application level protocol. Recently, SIP is being adopted in many systems due to its simple structure and excellent extension compared to more conventional protocols. SIP is a signal protocol used when a session is connected. SIP can be used for an Internet phone connection as well as visual telephone, multimedia, and online game connections. Request For Comments (RFC) 2543 was initially adopted as a standard and recently updated to RFC 3261.

A PTT service network can be embodied using a CDMA2000 1× system or a CDAM2000 1× EV-DO system. When a PTT user desires to make a call to another user, the calling user selects the called user and selects a call button or a service start button from a PTT terminal, thereby generating an invitation message in SIP format and transmitting the invitation message to a PTT server through a Base Station System (BSS), a Packet Control Function (PCF), or a Packet Data serving Node (PDSN). The PTT server receives the invitation message and sends a request to the BSS for paging of the received message. Here, the BSS covers a sub-net including a base station where an incoming terminal's location was last registered or where the incoming terminal was located just before entering a dormant state. Thus, upon receipt of the PTT server's request for paging of the invitation message, the BSS performs paging through the base station belonging to the sub-net.

In the CDMA2000 1× system, upon receipt of the request for paging of the invitation message, the BSS performs paging of a General Paging Message (GPM) or a specific order command message in preparation for cases where a location of the incoming terminal is not clearly detected and where a paging message is too large in size. Cases where the location of the incoming terminal is not clearly detected can include cases where the incoming terminal experiences a ping-pong phenomenon at an interface of the base stations, and where the location of the incoming terminal changes but is not re-registered to a different base station of the same sub-net in the dormant state. Further, the case where the paging message is too large corresponds to when the invitation message for the PTT service is transmitted in the form of a Short Data Burst (SDB) having a size of tens of bytes and the SDB is paged to all base stations belonging to a predetermined sub-net.

The CDMA2000 1× system performs the paging to detect the location of the incoming terminal and transmits a message to be actually paged, to the incoming terminal. Here, the message to be actually paged can be transmitted in the form of a Data Burst Message (DBM).

Meanwhile, in the CDMA2000 1× EV DO system, upon receipt of the PTT server's request for paging of the invitation message, the BSS pages a location request message in preparation for the case where the location of the incoming terminal is not clearly detected or where the paging message is too large in size. The CDMA2000 1× EV-DO system performs the paging to detect the location of the incoming terminal, and transmits the invitation message to the incoming terminal. Here, the transmitted invitation message is comprised of a Data Over Signaling (DOS) message.

However, when the invitation message is generated from an outgoing terminal and transmitted to the PTT server for the PTT service, the PTT server allocates internal resources for connecting a call between the outgoing terminal and the incoming terminal. However, it takes a long time to detect the location of the incoming terminal in order to transmit the invitation message to the incoming terminal after the PTT server internal resource assignment. This is disadvantageous when rapid transmission (within about one second) of the invitation message to the incoming terminal is required (e.g., within about one second).

### SUMMARY OF THE INVENTION

An exemplary objective of the present invention is to provide an apparatus and method for processing a call in a Push-To-Talk (PTT) system, wherein when an outgoing terminal transmits an invitation message for PTT service or for call setup to a predetermined incoming terminal in a dormant state, it transmits the invitation message together with address information on the incoming terminal to enable a PTT server to detect the location of the incoming terminal before the invitation message is transmitted to the incoming terminal, thereby reducing the time taken to setup a PTT call.

According to an exemplary aspect of the present invention, there is provided an apparatus for processing a call in a PTT (Push-To-Talk) system, the apparatus including a unit for receiving an invitation request message from an outgoing terminal to provide a PTT service to a predetermined incoming terminal, providing the received invitation request message to a PTT server, detecting a location of the incoming terminal using address information on the incoming terminal included in the invitation request message, and providing an invitation message generated from the PTT server to the incoming terminal whose location is detected. The PTT server receives the invitation request message from the unit, performs an internal resource assignment for performing a call connection between the outgoing terminal and the incoming terminal, and generates the invitation message for inviting the incoming terminal to the PTT service after completing the internal resource assignment.

According to an exemplary implementation of the present invention, the outgoing terminal and the incoming terminal may be located on the same network or different networks.

According to an exemplary embodiment of the present invention, when the PTT system comprises a CDMA2000 1× system, the address information on the incoming terminal may be expressed using either one of an IMSI (International Mobile Subscriber Identity) and a TMSI (Temporary Mobile Subscriber Identity), and when the PTT system is embodied using a CDMA2000 1× EV-DO system, the address information on the incoming terminal may be expressed using a UATI (Unicast Access Terminal Identifier).

According to an exemplary embodiment of the present invention, the internal resource assignment may comprise an operation for setting a CODEC (COder and DECoder) processing a packetized voice frame between the outgoing terminal and the incoming terminal.

According to an exemplary embodiment of the present invention, the unit may include a first processor for receiving the invitation request message from the outgoing terminal to provide the PTT service to the predetermined incoming terminal, and generating a location detection message to detect the location of the incoming terminal. The unit may also include a second processor for receiving the location detection message from the first processor, checking whether or not session information on the incoming terminal is set to be in a dormant state using address information on the incoming terminal included in the invitation request message, for requesting a base station system where the incoming terminal was last located to detect the location of the incoming terminal when it is found that the incoming terminal is in the dormant state, for transmitting the invitation message from the PTT server to the base station system when it is found that the incoming terminal is located at a sub-net of the base station system, and for requesting the PTT server to detect the location of the incoming terminal when it is found that the incoming terminal is not set to be in the dormant state.

According to an exemplary embodiment of the present invention, the unit may detect the location of the incoming terminal within a time during which the PTT server performs the internal resource assignment.

According to another exemplary aspect of the present invention, there is provided an apparatus for processing a call in a PTT (Push-To-Talk) system, the apparatus including a message generator for receiving an invitation request message from an outgoing terminal to provide a PTT service to a predetermined incoming terminal, and generating a location detection message to detect the location of the incoming terminal, a provider for detecting the location of the incoming terminal according to the location detection message, using address information on the incoming terminal included in the invitation request message, and providing an invitation message generated from a PTT server to the incoming terminal whose location is detected. The PTT server receives the invitation request message, perform]s an internal resource assignment for performing a call connection between the outgoing terminal and the incoming terminal, and generates an invitation message after completing the internal resource assignment.

According to another exemplary aspect of the present invention, there is provided an apparatus for processing a call in a PTT (Push-To-Talk) system, the apparatus including a PTT server for receiving an invitation request message from an outgoing terminal to provide a PTT service to a predetermined incoming terminal, performing an internal resource assignment for a call connection between the outgoing terminal and the incoming terminal, generating a terminal location request message including address information on the incoming terminal to detect the location of the incoming terminal, and upon detection of a base station system where the incoming terminal is located, generating an invitation message for inviting the incoming terminal to the PTT service. The apparatus also includes, for example, a unit for detecting the base station system where the incoming terminal is located, using the address information on the incoming terminal included in the terminal location request message, and transmitting the invitation message to the detected base station system where the incoming terminal is located.

The unit may include a processor for checking whether or not session information on the incoming terminal is set to be in a dormant state using address information on the incoming terminal included in the terminal location request message, requesting a base station system where the incoming terminal was last located to detect the location of the incoming terminal when it is found that the incoming terminal is in the dormant state, transmitting the invitation message to the base station system when it is found that the incoming terminal is located at a sub-net of the base station system, and requesting the PTT server to detect the location of the incoming terminal when it is found that the incoming terminal is not set to be in the dormant state.

According to yet another exemplary aspect of the present invention, there is provided a method for processing a call in a PTT (Push-To-Talk) system, the method including the steps of receiving an invitation request message from an outgoing terminal to provide a PTT service to a predetermined incoming terminal, and detecting a location of the incoming terminal using address information on the incoming terminal included in the invitation request message, performing an internal resource assignment for a call connection between the outgoing terminal and the incoming terminal, and after completing the internal resource assignment, generating an invitation message for inviting the incoming terminal to the PTT service and transmitting the generated invitation message to the incoming terminal whose location is detected.

According to an exemplary embodiment of the present invention, the step of detecting the location of the incoming terminal may include the steps of checking whether or not session information on the incoming terminal is set to be in a dormant state using address information on the incoming terminal. According to an exemplary embodiment of the present invention, when it is found that the incoming terminal is in the dormant state, the method further includes requesting a base station system where the incoming terminal was last located to detect the location of the incoming terminal; and when it is found that the incoming terminal is located at a sub-net of the base station system, transmitting the invitation message to the base station system.

According to an exemplary embodiment of the present invention, the method may further include the step of, when it is found that the incoming terminal is not in the dormant state, determining that the outgoing terminal and the incoming terminal are not located on the same network, and requesting a server, which is located between the same network and a different network and detects the locations of the terminals, to detect the location of the incoming terminal.

According to still yet another exemplary aspect of the present invention, there is provided a method for processing a call in a PTT (Push-To-Talk) system, the method including the steps of receiving an invitation request message from an outgoing terminal to provide a PTT service to a predetermined incoming terminal, providing the received invitation request message to a PTT server, receiving a location detection request message for detecting the location of the incoming terminal from the PTT server, and detecting a location of the incoming terminal using address information on the incoming terminal included in the location detection request message. According to an exemplary embodiment of the present invention, the method further includes completing an internal resource assignment for a call connection between the outgoing terminal and the incoming terminal, receiving an invitation message for inviting the incoming terminal to the PTT service from the PTT server, and transmitting the invitation message to the incoming terminal whose location is detected.

According to an exemplary embodiment of the present invention, the step of detecting the location of the incoming terminal may include the steps of checking whether or not session information on the incoming terminal is set to be in a dormant state using address information on the incoming terminal included in the location detection request message. According to an exemplary embodiment of the present invention, when it is found that the incoming terminal is in the dormant state, a base station system where the incoming terminal was last located is requested to detect the location of the incoming terminal, and when it is found that the incoming terminal is located at a sub-net of the base station system, transmitting the invitation message to the base station system.

According to an exemplary embodiment of the present invention, the step of detecting the location of the incoming terminal may further include the step of, when it is found that the incoming terminal is not in the dormant state, requesting the PTT server to detect the location of the incoming terminal.

### BRIEF DESCRIPTION OF THE DRAWINGS

A more complete appreciation of the present invention, and many of the attendant advantages thereof, will be more apparent and better understood by reference to the following detailed description of the exemplary embodiments of the present invention when considered in conjunction with the accompanying drawings, in which like reference symbols indicate the same or similar components, wherein:

FIG. 1 illustrates a network connection of a mobile communication network system according to an exemplary embodiment of the present invention;

FIG. 2 is a flowchart illustrating a call process in a PTT system according to an exemplary embodiment of the present invention;

FIG. 3 is a flowchart illustrating a call process in a PTT system according to another exemplary embodiment of the present invention;

FIG. 4 illustrates a format of a Data Burst Message (DBM) according to an exemplary embodiment of the present invention; and

FIG. 5 illustrates a format of an Extended System Parameter Message (ESPM) according to an exemplary embodiment of the present invention.

### DETAILED DESCRIPTION OF EXEMPLARY EMBODIMENTS

Reference will now be made in detail to exemplary embodiments of the present invention, examples of which are illustrated in the accompanying drawings wherein, as noted above, the same reference numerals will be used throughout the drawings to refer to the same or similar elements.

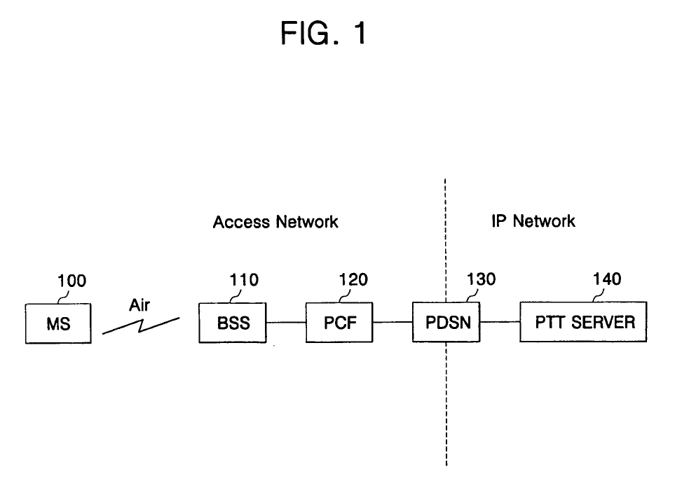

FIG. 1 illustrates a network connection of a mobile communication network system according to an exemplary embodiment of the present invention.

In an exemplary implementation, the mobile communication network system can be a CDMA2000 1× system or a CDMA2000 1× EV-DO system.

As shown in FIG. 1, the exemplary mobile communication network system includes a Mobile Station (MS) 100, a Base Station System (BSS) 110, a Packet Control Function (PCF) 120, a Packet Data Serving Node (PDSN) 130, and a Push-To-Talk (PTT) server 140.

The MS 100 and the BSS 110 are connected using a wireless link. The BSS 110, PCF 120, and PDSN 130 are connected by a wired network. The PDSN 130 is connected with the PTT server 140 using an Internet Protocol (IP) network.

In an exemplary implementation, a network including the BSS 110, the PCF 120, and the PDSN 130 is called an access network which enables the MS 100 to access the IP network. The PDSN 130 receives a packet signal from the PCF 120, and transmits the received packet signal as an IP signal over the Internet or an external/internal network. Therefore, the PDSN 130 serves to connect the IP network and the access network at an interface thereof.

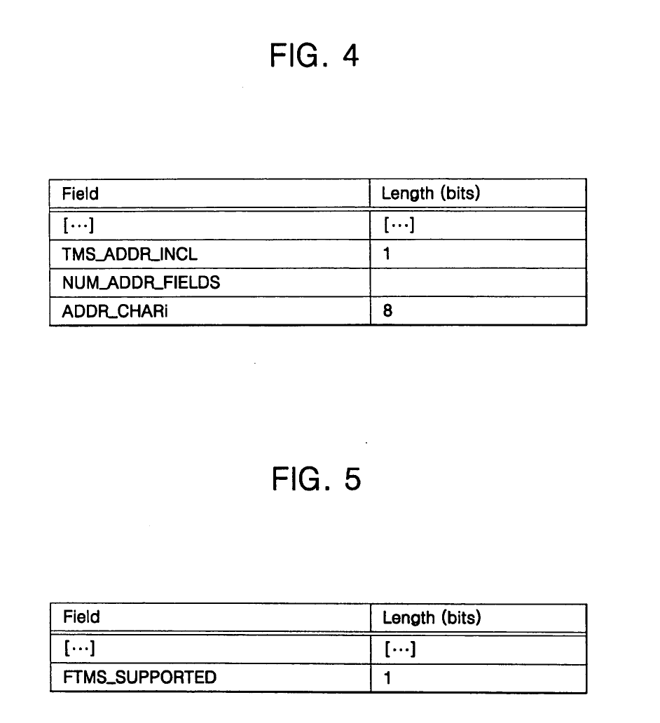

In an access state, the MS 100 allows a Data Burst Message (DBM) to include a call invitation message for the other party selected by a subscriber and address information on the other party's incoming terminal. MS 100 wirelessly transmits the DBM including the call invitation message and the address information to the BSS 110. Alternatively, in the access state, the MS 100 allows an origination reconnect message for setting a traffic channel to include the call invitation message for the other party selected by the subscriber and the address information on the other party's incoming terminal, and wirelessly transmits the origination reconnect message including the call invitation message and the address information to the BSS 110. Hereinafter, an example of a format of the DBM including the call invitation message and the address information will be described with reference to FIG. 4.

As shown in FIG. 4, the DBM includes a TMS_ADDR_INCL field, a NUM_ADDR_FIELDS field, and an ADDR_CHARi field. Symbol “[ . . . ]” of FIG. 4 denotes a field of the DBM.

The TMS_ADDR_INCL field represents whether or not the DBM includes the address information on the incoming terminal. If the TMS_ADDR_INCL field is set to “1”, it indicates that the DBM includes the address information on the incoming terminal. If the TMS_ADDR_INCL field is set to “0”, it indicates that the DBM does not include the address information on the incoming terminal. In an exemplary implementation, the address information on the incoming terminal is information corresponding to the NUM_ADDR_FIELDS field and the ADDR_CHARi field.

If the TMS_ADDR_INCL field is set to “1”, the NUM_ADDR_FIELDS field is included in the DBM and indicates an arrangement size of the address information on the incoming terminal in bytes.

The ADDR_CHARi field contains the address information on the incoming terminal, which is expressed by arrangement.

In the access state, the BSS 110 receives the invitation message for the other party and the address information on the other party's incoming terminal from the MS 100 of a service cell using the DBM or the origination reconnect message. Then, the BSS 110 converts the received invitation message and address information into a PPP (Point-to-Point Protocol) frame, and transmits the converted PPP frame to the PDSN 130 through the PCF 120. The PDSN 130 converts the received PPP frame into an IP packet, and transmits the converted IP packet to the PTT server 140. In an exemplary implementation, the transmitted IP packet includes call invitation information for the other party's incoming terminal.

Further, after the invitation message for the other party is converted into the PPP frame and the converted PPP frame is transmitted to the PTT server 140, the BSS 110 generates a terminal query message for detecting whether or not the incoming terminal is located in a coverage network of the PDSN 130, and transmits the generated terminal query message to the PCF 120. In an exemplary implementation, the terminal query message includes the address information on the incoming terminal.

When the BSS 110 receives a predetermined terminal location request message from the PCF 120, it transmits a paging message included in the received terminal location request message to all base stations belonging to its sub-net each paging period and requests the base stations for paging. In an exemplary implementation, if the BSS 110 belongs to the CDMA2000 1× system, the paging message can be a General Page Message (GPM), and if the BSS 110 belongs to the CDMA2000 1× EV-DO system, the paging message can be a location request message.

Further, when the BSS 110 receives a reply message from the corresponding incoming terminal after the transmitting of the paging message, it generates a terminal location determination message including location information of the base station from which the reply message is come, and transmits the generated location determination message to the PCF 120.

After that, when the BSS 110 receives the PPP frame including call invitation message information from the PCF 120, using a predetermined outgoing terminal and the incoming terminal located within a coverage of the predetermined outgoing terminal, it converts the received PPP frame into the DBM and transmits the converted DBM to the incoming terminal.

In a paging state, the BSS 110 allows an Extended System Parameter Message (ESPM) or an ANSI-41 System Parameter Message (SPM) to include information on whether or not there is a support for detecting the location of the incoming terminal, and wirelessly transmits the ESPM or the ANSI-41 SPM to the MS 100. In an exemplary implementation, the ESPM or the ANSI-41 SPM including the information on whether or not there is the support for detecting the location of the incoming terminal is exemplified in FIG. 5.

As shown in FIG. 5, the ESPM or the ANSI-41 SPM includes a terminal location detection support field (FTMS_SUPPORTED). The terminal location detection support field (FTMS_SUPPORTED) represents whether or not, when the outgoing terminal provides the BSS 110 with the address information on the incoming terminal in the dormant state, the BSS 110 can perform an operation of detecting the location of the incoming terminal using the address information on the incoming terminal before the transmitting of the invitation message. If the terminal location detection support field is set to “1”, it indicates that the BSS 110 supports the detection of the location of the incoming terminal in the dormant state. If the terminal location detection support field is set to “0”, it indicates that the BSS 110 does not support the detection of the location of the incoming terminal in the dormant state.

The PCF 120 receives the PPP frame, which includes the call invitation message information for a predetermined incoming terminal, from the BSS 110, and transmits the received PPP frame to the PTT server 140. Or, the PCF 120 receives the PPP frame, which includes the call invitation message information for the incoming terminal MS 100 provided from a predetermined outgoing terminal, from the PTT server 140, and transmits the received PPP frame to the BSS 110. In an exemplary implementation, the transmitted PPP frame includes cell information of the BSS where the MS 100 being the incoming terminal was last located.

According to an exemplary embodiment of the present invention, when the PCF 120 receives the terminal query message from the BSS 110, it checks whether or not session information on the corresponding incoming terminal is in the dormant state on the coverage network of the PDSN 130, using the address information on the incoming terminal included in the terminal query message. When the corresponding incoming terminal is in the dormant state, the PCF 120 generates and provides the terminal location request message for detecting whether or not the incoming terminal is located in the BSS 110, to the BSS 110 where the incoming terminal was last located. In an exemplary implementation, the terminal location request message includes information on a generation period of the paging message. The paging message is generated from the BSS 110 where the incoming terminal was last located, to detect the location of the incoming terminal.

When the PCF 120 receives the terminal location request message for detecting the location of the incoming terminal, from the PTT server 140, it checks whether or not the corresponding incoming terminal is in the dormant state on the coverage network of the PDSN 130. When it is found that the corresponding incoming terminal is in the dormant state, the PCF 120 determines that the outgoing terminal and the incoming terminal are located on the same network. In an exemplary implementation, the same network indicates a network covered by the PDSN 130, and whether a network is the same or not is determined using IP address information of the PDSN 130.

If it is determined that the outgoing terminal and the incoming terminal are located on the same network, the PCF 120 generates and provides a terminal location detection message to detect whether or not the incoming terminal is located in the BSS to the BSS where the incoming terminal was last located. In an exemplary implementation, the terminal location detection message includes information on the generation period of the paging message. The paging message is generated from the BSS 110 where the incoming terminal was last located, to detect the location of the incoming terminal. On the other hand, if it is determined that the outgoing terminal and the incoming terminal are not on the same network, the PCF 120 requests the PTT server 140 to detect the location of the incoming terminal. Accordingly, the PTT server 140 requests a PDSN (not shown) other than the same network to detect the location of the incoming terminal within the time taken for internal resource assignment.

When the PTT server 140 receives the PPP frame, which includes the call invitation message information for the predetermined incoming terminal, through the BSS 110, the PCF 120, and the PDSN 130, it performs the internal resource assignment and then, transmits the corresponding PPP frame to the PCF 120. In an exemplary implementation, the internal resource assignment means that when the PTT server 140 receives the invitation message, it assigns and sets a COder and DECoder (CODEC) to a PTT media server (not shown) necessary for the call between the outgoing terminal and the incoming terminal. The CODEC processes a packetized voice frame provided in Real-time Transport Protocol (RTP) format from the outgoing terminal and the incoming terminal.

If the PTT server 140 receives the PPP frame, which includes the call invitation message information for the predetermined incoming terminal and is generated by the MS 100, from the PCF 120, and performs an operation for detecting the location of the incoming terminal before the internal resource assignment, it generates and transmits the terminal location request message to the PCF 120. This is an exemplary operation for enabling the PTT server 140 itself to detect the location of the incoming terminal when the PTT server 140 does not receive the address information on the incoming terminal from the MS 100.

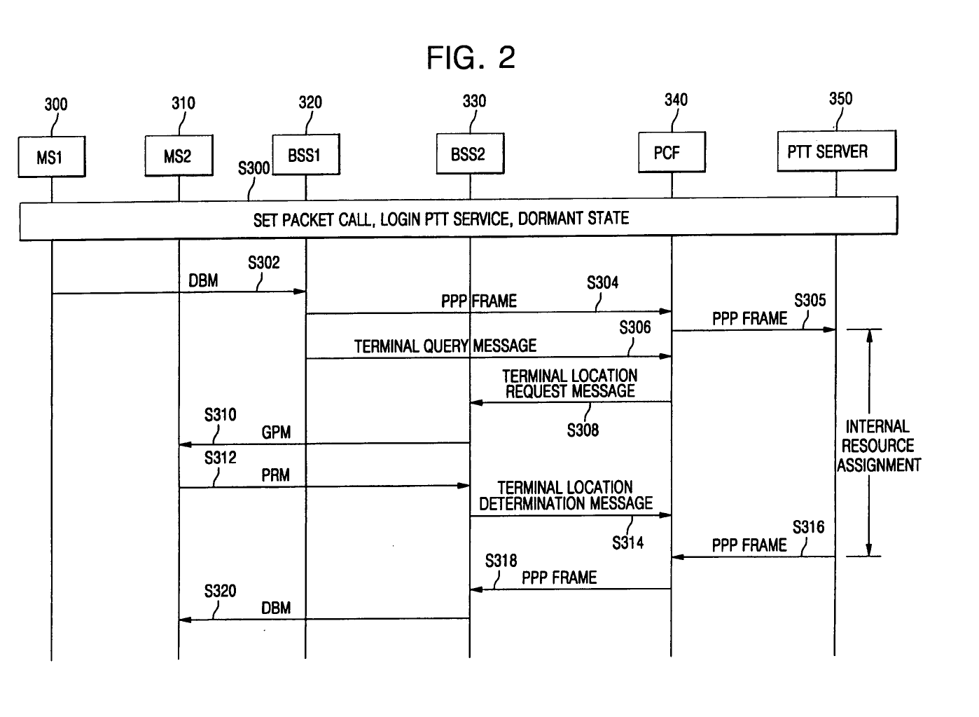

FIG. 2 is a flowchart illustrating a call process in a PTT system according to an exemplary embodiment of the present invention.

In an exemplary implementation, a Mobile Station 1 (MS1) 300 denotes the outgoing terminal, and a Mobile Station 2 (MS2) 310 denotes the incoming terminal. Further, a Base Station System 1 (BSS1) 320 denotes a base station system where the MS1 300 is located, and a Base Station System 2 (BSS2) 330 denotes a base station system where the MS2 310 is located. In this embodiment, the PTT system is embodied using the CDMA2000 1× system, but the PTT system can naturally also be embodied using the CDMA2000 1× EV-DO system.

As shown in FIG. 2, the MS1 300 sets up a packet call to perform a PPP login for a data service such as the Internet, logs into a PTT server 350 for PTT service, and receives the address information on an intended call recipient's incoming terminal, or address information on an interesting terminal, from the PTT server 350. The received terminal address information also includes address information on the MS2 310. The received terminal address information can be an International Mobile Subscriber Identity (IMSI), a Temporary Mobile Subscriber Identify (TMSI), and the like in the CDMA2000 1× system, and can be a Unicast Access Terminal Identifier (UATI) in the CDMA2000 1× EV-DO system.

In a state where the MS1 300 becomes dormant by setting up the packet call and logging into the PTT server 350 for the PTT service (Step S300), the MS1 300 allows the DBM to include the invitation message information for the MS2 310 and the address information on the MS2 310, based on a user's call invitation request for the MS2 310, and transmits the DBM including the invitation message information and the address information to the BSS1 320 (Step S302).

Accordingly, the BSS1 320 receives the DBM from the MS1 300, converts the received DBM into PPP frame format, and transmits the converted PPP frame to the PTT server 350 (Step S305) via the PCF 340 (Step S304).

After that, the BSS1 320 generates and provides the terminal query message, which includes the address information on the MS2 310, to the PCF 340 in order to detect the location of the MS2 310 (Step S306).

The PCF 340 checks whether or not the MS2 310 is in the dormant state on the coverage network of the PDSN (not shown) to which the PCF 340 belongs. When it is found that the MS2 310 is in the dormant state, the PCF 340 generates and transmits the terminal location request message for determining the location of the MS2 310 to the BSS where the MS2 310 was last located. In an exemplary implementation, the BSS2 330 denotes the base station system where the MS2 310 was last located. In other words, the PCF 340 generates and transmits the terminal location request message for determining the location of the MS2 310, to the BSS2 330 where the MS2 310 was last located (Step S308). In an exemplary implementation, the terminal location request message includes the information on the generation period of the paging message, which is generated by the BSS2 330 to detect the location of the MS2 310.

The BSS2 330 receives the terminal location request message from the PCF 340, generates the GPM at each generation period of the paging message included in the received terminal location request message, and broadcasts the generated GPM to all base stations belonging to its sub-net (Step S310).

Next, when the BSS2 330 receives a Page Response Message (RPM) from the MS2 310 responding to the GPM (Step S312), it generates and provides the terminal location determination message to the PCF 340 (Step S314). In an exemplary implementation, the RPM and the terminal location determination message include cell information of the BSS2 330 where the MS2 310 is located.

When the PCF 340 receives the terminal location determination message from the BSS2 330, and then receives the PPP frame, which includes the invitation message for inviting the MS2 310 to the call, from the PTT server 350 (Step 316), it transmits the received PPP frame to the BSS2 330 (Step S318). In an exemplary implementation, the PPP frame transmitted from the PCF 340 to the BSS2 330 includes the cell information of the BSS2 330 where the MS2 310 is located.

Next, the BSS2 330 allows the DBM to include the invitation message included in the PPP frame transmitted from the PCF 340, and provides the DBM including the invitation message to the MS2 310 (Step S320).

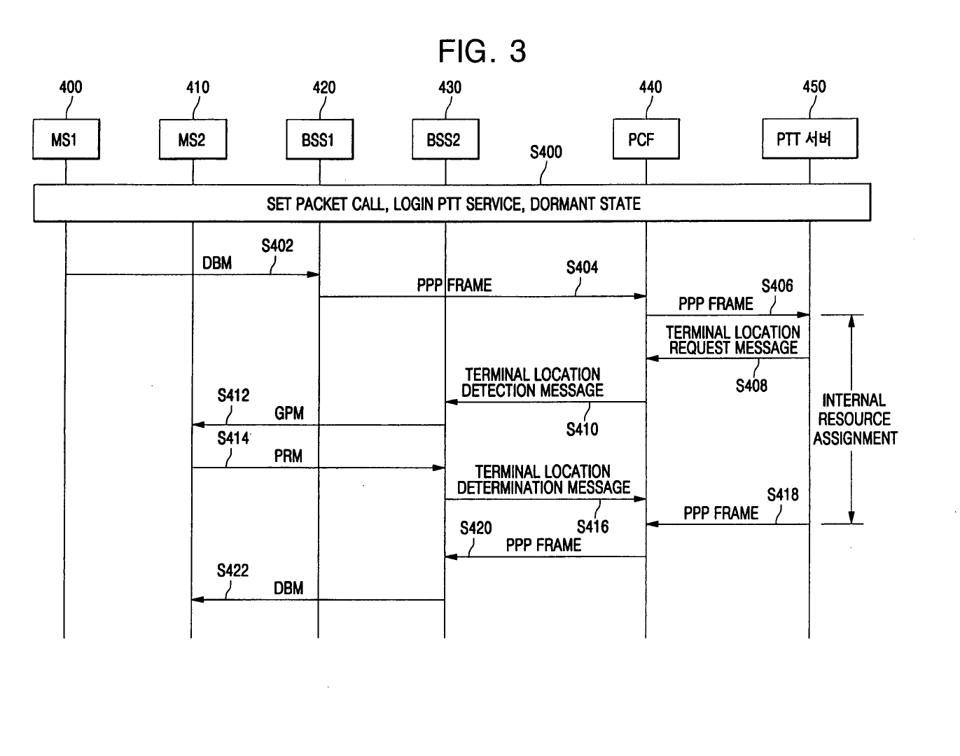

FIG. 3 is a flowchart illustrating a call process in a PTT system according to another exemplary embodiment of the present invention.

According to an exemplary implementation, a Mobile Station 1 (MS1) 400 denotes the outgoing terminal, and a Mobile Station 2 (MS2) 410 denotes the incoming terminal. Further, a Base Station System 1 (BSS1) 420 denotes a base station system where the MS1 400 is located, and a Base Station System 2 (BSS2) 430 denotes a base station system where the MS2 410 is located. In this embodiment, the PTT system is embodied using the CDMA2000 1× system, but the PTT system can naturally also be embodied using the CDMA2000 1× EV-DO system.

As shown in FIG. 3, the MS1 400 sets a packet call, logs into a PTT server 450 for a PTT service, and receives the address information on the intended call recipient's incoming terminal or address information on an interesting terminal, from the PTT server 450. The terminal address information transmitted from the PTT server 450 also includes address information on the MS2 410. The transmitted terminal address information can be an International Mobile Subscriber Identity (IMSI), a Temporary Mobile Subscriber Identify (TMSI), and the like in the CDMA2000 1× system, and can be a Unicast Access Terminal Identifier (UATI) in the CDMA2000 1× EV-DO system.

In a state where the MS1 400 becomes dormant by setting up the packet call and logging into the PTT server 450 for the PTT service (Step S400), the MS1 400 allows the DBM to include the invitation message information for the MS2 410, based on a user's call invitation request for the MS2 410, and transmits the DBM which includes the invitation message information to the BSS1 420 (Step S402).

Accordingly, the BSS1 420 receives the DBM from the MS1 400, converts the received DBM into PPP frame format, and transmits the converted PPP frame to the PTT server 450 (Step S406) via the PCF 440 (Step S404).

After that, the PTT server 450 generates and provides the terminal location request message including the address information on the MS2 410 to the PCF 440 in order to detect the location of the MS2 410 (Step S408).

When the PCF 440 receives the terminal location request message from the PTT server 450, it checks whether or not the MS2 410 is in the dormant state on the coverage network of the PDSN (not shown) to which the PCF 440 belongs. When it is found that the MS2 410 is in the dormant state, it is checked whether the MS1 400 and the MS2 410 are located on the same network.

When it is found that the MS1 400 and the MS2 410 are located on the same network, the PCF 440 generates and transmits the terminal location detection message for determining the location of the MS2 410 to the BSS where the MS2 410 was last located. In an exemplary implementation, the BSS where the MS2 410 was last located is the BSS2 430. In other words, the PCF 440 generates and transmits the terminal location detection message for determining the location of the MS2 410 to the BSS2 430 where the MS2 410 was last located (Step S410). In an exemplary implementation, the terminal location detection message includes the information on the generation period of the paging message, which is generated to detect the location of the MS2 410 by the BSS2 430.

On the other hand, when it is found that the MS1 400 and the MS2 410 are not on the same network, the PCF 440 requests the PTT server 450 to detect the location of the incoming terminal. Accordingly, the PTT server 450 requests the PDSN other than the same network for detection of the incoming terminal location during the time it takes to perform the internal resource assignment.

The BSS2 430 receives the terminal location request message from the PCF 440, generates the GPM at each generation period of the paging message included in the received terminal location request message, and broadcasts the generated GPM to all base stations belonging to its sub-net (Step S412).

Next, when the BSS2 430 receives a Page Response Message (RPM) from the MS2 410 responding to the GPM (Step S414), it generates and provides the terminal location determination message to the PCF 440 (Step S416). In an exemplary implementation, the RPM and the terminal location determination message include cell information of the BSS2 430 where the MS2 410 is located.

When the PCF 440 receives the terminal location determination message from the BSS2 430, and then receives the PPP frame which includes the invitation message for inviting the MS2 410 to the call from the PTT server 450 (Step 418), it transmits the received PPP frame to the BSS2 430 (Step 420). In an exemplary implementation, the PPP frame transmitted from the PCF 440 to the BSS2 430 includes the cell information of the BSS2 430 where the MS2 410 is located.

Next, the BSS2 430 allows the DBM to include the invitation message included in the PPP frame transmitted from the PCF 440, and provides the DBM including the invitation message to the MS2 410 (Step 422).

Meanwhile, the inventive call processing method shown in FIG. 2 is applied to a case where the outgoing terminal and the incoming terminal are located on the same network, and the inventive call processing method shown in FIG. 3 is applied both to the case where the outgoing terminal and the incoming terminal are located on the same network and the case where the outgoing terminal and the incoming terminal are located on different networks.

Further, in the call processing method shown in FIG. 2, the outgoing terminal, that is, the MS1 300 transmits the invitation message including the address information on the incoming terminal to the incoming terminal, but in the call processing method shown in FIG. 3, the outgoing terminal, that is, the MS1 400 transmits the invitation message not including the address information on the incoming terminal to the incoming terminal. In this respect, the call processing methods shown in FIGS. 2 and 3 are different.

Furthermore, in the call processing method shown in FIG. 2, the BSS1 320 receives the invitation message from the MS1 300 and requests the PCF 340 to detect the location of the incoming terminal. In contrast, in the call processing method shown in FIG. 3, the PTT server 450 directly requests the PCF 440 to detect the location of the incoming terminal. In this respect, the call processing methods shown in FIGS. 2 and 3 are different.

A call processing method according to yet another exemplary embodiment of the present invention can be realized using the above-described exemplary call processing methods shown in FIGS. 2 and 3.

In exemplary embodiments of the present invention, the base station system receives the invitation message and the address information on the incoming terminal from the outgoing terminal to provide the PTT service to the incoming terminal, and checks its PCF to determine whether or not the session information on the incoming terminal is in the dormant state. If it is found that the session information on the corresponding incoming terminal is in the dormant state, the PCF determines that the outgoing terminal and the incoming terminal are located on the same network and requests the PTT server not to generate the message for detecting the location of the incoming terminal. On the other hand, if it is found that the session information on the corresponding incoming terminal is not in the dormant state, the PCF determines that the outgoing terminal and the incoming terminal are not located on the same network and requests the PTT server to detect the location of the incoming terminal in the PDSN other than the PDSN to which the PCF belongs. As the PCF requests the PDSN other than the PDSN to which the PCF belongs to detect the location of the incoming terminal, the PTT server requests the PDSN other than the PDSN to which the PCF belongs to detect the location of the incoming terminal. In an exemplary implementation, the detecting of the location of the incoming terminal is performed within the time taken to perform internal resource assignment in the PTT server.

In exemplary embodiments of call processing apparatus and method according to the present invention, when the outgoing terminal transmits the invitation message for the PTT service or the invitation message for the call setup to the predetermined incoming terminal in the dormant state, it transmits it together with the address information on the incoming terminal to enable the PTT server to detect the location of the incoming terminal before transmitting the invitation message for the PTT service to the incoming terminal, thereby reducing the time taken to set up the PTT call.

While exemplary embodiments of the present invention have been described with reference to exemplary implementations thereof, it will be understood by those skilled in the art that various changes and modifications may be made therein without departing from the scope of the present invention as defined by the following claims.

What is claimed is:

1. An apparatus for processing a call in a PTT (Push-To-Talk) system, the apparatus comprising:
a receiving unit; and
a PTT server; wherein
the receiving unit
receives an invitation request message from an outgoing terminal to provide a PTT service to an incoming terminal, the invitation request message comprising address information on the incoming terminal,
provides the received invitation request message to the PTT server,
detects a location of the incoming terminal using the address information on the incoming terminal, and
provides an invitation message generated from the PTT server to the incoming terminal; and
the PTT server
receives the invitation request message from the unit,
performs an internal resource assignment for performing a call connection between the outgoing terminal and the incoming terminal, and
generates the invitation message for inviting the incoming terminal to the PTT service after completing the internal resource assignment.

2. The apparatus according to claim 1, wherein locations of the outgoing terminal and the incoming terminal comprise at least one of locations on the same network and locations on different networks.

3. The apparatus according to claim 1, wherein when the PTT system comprises a CDMA2000 1× system, the address information on the incoming terminal comprises at least one of an IMSI (International Mobile Subscriber Identity) and a TMSI (Temporary Mobile Subscriber Identity), and
when the PTT system comprises a CDMA2000 1× EV-DO system, the address information on the incoming terminal comprises a UATI (Unicast Access Terminal Identifier).

4. The apparatus according to claim 1, wherein the internal resource assignment comprises an operation for setting a CODEC (COder and DECoder) processing a packetized voice frame between the outgoing terminal and the incoming terminal.

5. The apparatus according to claim 1, wherein the receiving unit comprises:
a first processor for receiving the invitation request message from the outgoing terminal to provide the PTT service to the incoming terminal, and for generating a location detection message to detect the location of the incoming terminal; and
a second processor for receiving the location detection message from the first processor, determining whether or not session information on the incoming terminal is set to be in a dormant state using the address information on the incoming terminal, for requesting a base station system where the incoming terminal was last located to detect the location of the incoming terminal when the session information on the incoming terminal is determined to be set to be in the dormant state, for transmitting the invitation message received from the PTT server to the base station system when the location of the incoming terminal is determined to be at a sub-net of the base station system, and for requesting the PTT server to detect the location of the incoming terminal when the session information on the incoming terminal is determined not to be set to be in the dormant state.

6. The apparatus according to claim 1, wherein the receiving unit detects the location of the incoming terminal within a time during which the PTT server performs the internal resource assignment.

7. An apparatus for processing a call in a PTT (Push-To-Talk) system, the apparatus comprising:
a PTT server;
a message generator for receiving an invitation request message from an outgoing terminal to provide a PTT service to an incoming terminal, and for generating a location detection message to detect the location of the incoming terminal, the location detection message comprising address information on the incoming terminal; and
a provider for detecting the location of the incoming terminal according to the location detection message, using the address information on the incoming terminal, and for providing an invitation message generated from the PTT server to the incoming terminal whose location is detected;
wherein the PTT server
receives the invitation request message,
performs an internal resource assignment for performing a call connection between the outgoing terminal and the incoming terminal, and
generates an invitation message after completing the internal resource assignment.

8. The apparatus according to claim 7, wherein locations of the outgoing terminal and the incoming terminal comprise at least one of locations on the same network and locations on different networks.

9. An apparatus for processing a call in a PTT (Push-To-Talk) system, the apparatus comprising:
a PTT server for receiving an invitation request message from an outgoing terminal to provide a PTT service to an incoming terminal, for performing an internal resource assignment for a call connection between the outgoing terminal and the incoming terminal, for generating a terminal location request message comprising address information on the incoming terminal to detect the location of the incoming terminal, and for, upon detection of a base station system where the incoming terminal is located, generating an invitation message for inviting the incoming terminal to the PTT service; and
a receiving unit for detecting the base station system where the incoming terminal is located, using the address information on the incoming terminal, and for transmitting the invitation message to the detected base station system where the incoming terminal is located.

10. The apparatus according to claim 9, wherein locations of the outgoing terminal and the incoming terminal comprise at least one of locations on the same network and locations on different networks.

11. The apparatus according to claim 9, wherein when the PTT system comprises a CDMA2000 1× system, the address information on the incoming terminal comprises at least one of an IMSI (International Mobile Subscriber Identity) and a TMSI (Temporary Mobile Subscriber Identity), and
when the PTT system comprises a CDMA2000 1× EV-DO system, the address information on the incoming terminal comprises a UATI (Unicast Access Terminal Identifier).

12. The apparatus according to claim 9, wherein the internal resource assignment comprises an operation for setting a CODEC (COder and DECoder) processing a packetized voice frame between the outgoing terminal and the incoming terminal.

13. The apparatus according to claim 9, wherein the receiving unit comprises:
a processor for determining whether or not session information on the incoming terminal is set to be in a dormant state using the address information on the incoming terminal, requesting a base station system where the incoming terminal was last located to detect the location of the incoming terminal when the session information on the incoming terminal is determined to be set to be in the dormant state, transmitting the invitation message to the base station system when the location of the incoming terminal is determined to be at a sub-net of the base station system, and requesting the PTT server to detect the location of the incoming terminal when the session information on the incoming terminal is determined not to be set to be in the dormant state.

14. The apparatus according to claim 9, wherein the receiving unit detects the location of the incoming terminal within a time during which the PTT server performs the internal resource assignment.

15. A method for processing a call in a PTT (Push-To-Talk) system, the method comprising the steps of:
receiving an invitation request message from an outgoing terminal to provide a PTT service to a incoming terminal, the invitation request comprising address information on the incoming terminal;
detecting a location of the incoming terminal using the address information on the incoming terminal; and
performing an internal resource assignment for a call connection between the outgoing terminal and the incoming terminal;
after completing the internal resource assignment, generating an invitation message for inviting the incoming terminal to the PTT service; and
transmitting the generated invitation message to the incoming terminal.

16. The method according to claim 15, wherein locations of the outgoing terminal and the incoming terminal comprises at least one of locations on the same network or locations on different networks.

17. The method according to claim 15, wherein when the PTT system comprises a CDMA2000 1× system, the address information on the incoming terminal comprises at least one of an IMSI (International Mobile Subscriber Identity) and a TMSI (Temporary Mobile Subscriber Identity), and
when the PTT system comprises a CDMA2000 1× EV-DO system, the address information on the incoming terminal comprises a UATI (Unicast Access Terminal Identifier).

18. The method according to claim 15, wherein the step of performing of the internal resource assignment comprises setting a CODEC (COder and DECoder) processing a packetized voice frame between the outgoing terminal and the incoming terminal.

19. The method according to claim 15, wherein the step of detecting the location of the incoming terminal comprises the steps of:
determining whether or not session information on the incoming terminal is set to be in a dormant state using the address information on the incoming terminal;
when the session information on the incoming terminal is determined to be set to be in the dormant state, requesting a base station system where the incoming terminal was last located to detect the location of the incoming terminal; and
when the location of the incoming terminal is detected to be at a sub-net of the base station system, transmitting the invitation message to the base station system.

20. The method according to claim 19, further comprising the steps of:
when the session information on the incoming terminal is determined not to be set to be in the dormant state, determining that the outgoing terminal and the incoming terminal are not located on the same network; and
requesting a server, which is located between the same network and a different network and which is configured to detect terminal locations, to detect the location of the incoming terminal.

21. A method for processing a call in a PTT (Push-To-Talk) system, the method comprising the steps of:
receiving an invitation request message from an outgoing terminal to provide a PTT service to an incoming terminal;
providing the received invitation request message to a PTT server;
receiving a location detection request message for detecting the location of the incoming terminal from the PTT server, the location detection request comprising address information on the incoming terminal;
detecting a location of the incoming terminal using the address information on the incoming terminal;
completing an internal resource assignment for a call connection between the outgoing terminal and the incoming terminal;
receiving an invitation message for inviting the incoming terminal to the PTT service from the PTT server; and
transmitting the invitation message to the incoming terminal.

22. The method according to claim 21, wherein locations of the outgoing terminal and the incoming terminal comprise at least one of locations on the same network and locations on different networks.

23. The method according to claim 21, wherein when the PTT system comprises a CDMA2000 1× system, the address information on the incoming terminal comprises at least one of an IMSI (International Mobile Subscriber Identity) and a TMSI (Temporary Mobile Subscriber Identity), and
when the PTT system comprises a CDMA2000 1× EV-DO system, the address information on the incoming terminal comprises a UATI (Unicast Access Terminal Identifier).

24. The method according to claim 21, wherein the step of completing of the internal resource assignment comprises setting a CODEC (COder and DECoder) processing a packetized voice frame between the outgoing terminal and the incoming terminal.

25. The method according to claim 21, wherein the step of detecting the location of the incoming terminal comprises the steps of:
determining whether or not session information on the incoming terminal is set to be in a dormant state using the address information on the incoming terminal;
when the session information on the incoming terminal is determined to be set to be in the dormant state, requesting a base station system where the incoming terminal was last located to detect the location of the incoming terminal; and
when the location of the incoming terminal is detected to be at a sub-net of the base station system, transmitting the invitation message to the base station system.

26. The method according to claim 25, further comprising the step of, when the session information on the incoming terminal is determined not to be set to be in the dormant state, requesting the PTT server to detect the location of the incoming terminal.
